(19) United States
(12) Patent Application Publication
(10) Pub. No.: US 2019/0329304 A1
(43) Pub. Date: Oct. 31, 2019

(54) METHOD OF CLEANING DRILLING FLUID TANKS AND ADMIXTURES THEREOF

(71) Applicant: Jet Cycle LLC, Shreveport, LA (US)

(72) Inventors: Thomas Smith, Shreveport, LA (US); Jeremy Fuqua, Jena, LA (US)

(73) Assignee: Jet Cycle LLC, Shreveport, LA (US)

(21) Appl. No.: 15/962,134

(22) Filed: Apr. 25, 2018

(51) Int. Cl. B08B 9/093; B63B 57/02

(52) U.S. Cl. CPC B08B 9/0933; E21B 21/01; B08B 9/0936; B63B 57/02

(57) ABSTRACT

A method of cleaning drilling fluid tanks is provided. The method includes washing drilling fluid within a first tank with fuel oil thereby forming a first admixture of drilling fluid and fuel oil. The method further includes reclaiming the first admixture and washing drilling fluid within a second tank with the reclaimed first admixture. The method further includes reclaiming a second admixture formed by the first admixture and the drilling fluid from the second tank. The method further includes washing drilling fluid within a third tank with the reclaimed second admixture.

### BACKGROUND

The subject disclosure relates generally to cleaning drilling fluid tanks. In particular, the subject disclosure relates to a method for cleaning tanks and other containers including, but not necessarily limited to, tanks associated with land-based drilling rigs.

Tanks, reservoirs, containers and other similar enclosures are commonly used to store liquids in connection with numerous industries including, but not necessarily limited to, the oil and gas industry. With respect to oil and gas operations, drilling fluid tanks are frequently utilized on land-based drilling operation sites to store and/or transport a variety of different fluids including, without limitation, drilling fluids.

Cleaning drilling fluid tanks often prove to be a difficult, expensive and time consuming process. Conventional drilling operations utilize water, soap, or other cleaning agent(s) to rinse drilling fluid residue, solids and debris from the inner surfaces of the drilling fluid tanks. However, such cleaning agents to do not react well with oil-based drilling fluids. As a result, the resulting mixtures of cleaning agents and oil-based drilling fluid must be disposed of because the resulting mixtures cannot be used again. Such existing cleaning operations result in inefficient and costly drilling operations because the drilling fluid cannot be reused and must be disposed in an environmentally safe manner.

Thus, there is still a need for an improved method for cleaning drilling fluid tanks that address the foregoing issues of conventional methods for cleaning such drilling fluid tanks.

### BRIEF SUMMARY

In accordance with an exemplary embodiment, the subject disclosure provides a method of cleaning drilling fluid tanks comprising the steps of washing drilling fluid within a first tank with fuel oil thereby forming a first admixture of drilling fluid and fuel oil, reclaiming the first admixture, and washing drilling fluid within a second tank with the reclaimed first admixture.

In an aspect of the exemplary embodiment, the method further includes the steps of reclaiming a second admixture formed by the first admixture and the drilling fluid from the second tank and washing drilling fluid within a third tank with the reclaimed second admixture. The method further includes the step of filtering the first admixture before washing the second tank. The step of filtering includes filtration by shale shaker at a requested screen size based on customer preferences. Additionally, the step of washing includes spraying the drilling fluid with the fuel oil at pressures of about 120 to 180 psi. In an aspect, the fuel oil is diesel fuel. However, the fuel oil can be e.g., diesel, gasoline, kerosene, crude oil and the like. Furthermore, the first tank is a mobile tank that can be located at a drilling site.

In accordance with another exemplary embodiment, the subject disclosure provides a method of forming a cleaning fluid for cleaning drilling fluid tanks that comprises admixing a fuel oil and a drilling fluid within a first tank forming a first admixture, filtering the first admixture, and admixing the first admixture with a drilling fluid within a second tank forming a second admixture.

In an aspect of the exemplary embodiment, the method further includes the step of filtering the second admixture. The first admixture comprises at least 50 mass % fuel oil. In an aspect, the fuel oil is diesel fuel. However, the fuel oil can be e.g., diesel, gasoline, kerosene, crude oil and the like. Furthermore, the first tank is a mobile tank that can be located at a drilling site.

In accordance with yet another exemplary embodiment, the subject disclosure provides a method of forming a drilling fluid composition that comprises mixing fuel oil with virgin drilling fluid within a first tank thereby forming a first admixture, filtering the first admixture, mixing the filtered first admixture with virgin drilling fluid within a second tank thereby forming a second admixture, and filtering the second admixture.

In an aspect of the exemplary embodiment, the method further includes the step of mixing the filtered second admixture with virgin drilling fluid within a third tank thereby forming a third admixture. The method can also include the step of filtering the third admixture. In an aspect, the fuel oil is diesel fuel. However, the fuel oil can be e.g., diesel, gasoline, kerosene, crude oil and the like. Furthermore, the first tank is a mobile tank that can be located at a drilling site.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the subject disclosure, there are shown in the drawings exemplary embodiments. It should be understood, however, that the invention is not limited to the precise arrangements and instrumentalities shown.

In the drawings:

FIG. 1 is a simplified view of an exemplary drilling rig with drilling fluid tanks applicable to the exemplary embodiments of the subject disclosure;

FIG. 2 is a perspective view of a drilling fluid tank in accordance with an exemplary embodiment of the subject disclosure;

FIG. 3 is a flow diagram illustrating a method of cleaning drilling fluid tanks in accordance with an exemplary embodiment of the subject disclosure;

FIG. 4 is a flow diagram illustrating a method of forming a cleaning fluid for cleaning drilling fluid tanks in accordance with an exemplary embodiment of the subject disclosure; and

FIG. 5 is a flow diagram illustrating a method of forming a drilling fluid composition in accordance with an exemplary embodiment of the subject disclosure.

### DETAILED DESCRIPTION OF THE INVENTION

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

Throughout this disclosure, various aspects of the subject disclosure can be presented in a range format. It should be understood that the description in range format is merely for convenience and brevity and should not be construed as an inflexible limitation on the scope of the exemplary embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the exemplary embodiments can be practiced without one or more of the specific features or advantages of a particular embodiment. In other instances, additional features and advantages may be recognized in certain embodiments that may not be present in all exemplary embodiments of the subject disclosure.

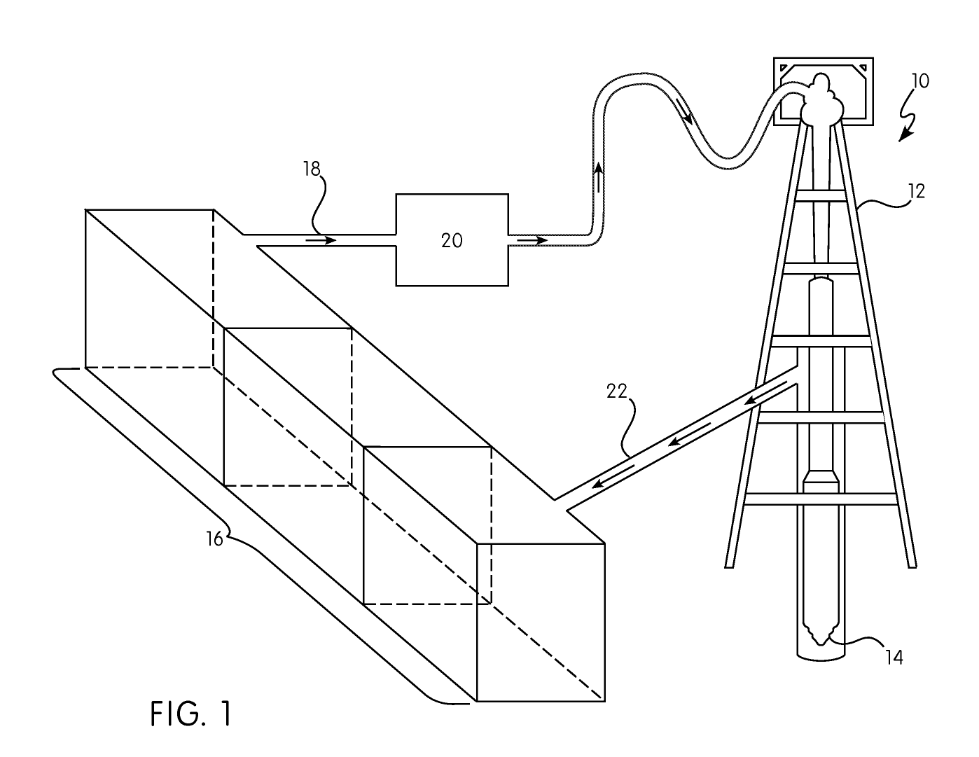

Referring now to FIG. 1, there is shown a drilling rig 10 for drilling e.g., wellbores. An engineering fluid frequently used in drilling operations conducted by the drilling rig 10 is drilling fluid or “drilling mud.” In accordance with an aspect of the exemplary embodiment, the drilling fluid can be an oil-based liquid that includes entrained solids. The drilling rig 10 can include a derrick 12 for supporting equipment used to lower and raise the drill assembly during drilling operations. During drilling operations, a drill bit 14 is used to break apart rock when drilling wellbores. Typically, the drill bit 14 includes jets through which the drilling fluid exits. The drilling fluid can be utilized on a drilling site to cool and lubricate the drill bit 14, remove cuttings and debris, and ensure wellbore stability during drilling operations.

Generally, a drilling site will have a plurality of drilling fluid tanks 16 e.g., a mobile drilling fluid tank for storing drilling fluid for use in future drilling operations as well as for transporting drilling fluid to other drilling sites. On a drilling site, drilling fluid is pumped from the drilling fluid tanks 16 to the drilling rig 10 through a suction line 18. The suction line 18 is an intake line for a mud pump 20 to draw drilling fluid from the drilling fluid tanks. In operation, drilling fluid is pumped from the drilling fluid tanks 16 to the drill bit 14 where it sprays out of nozzles and cools and cleans the drill bit in the process. The drilling fluid then returns to the surface and is returned to the drilling fluid tanks 16 through a drill line 22 for further treatment and storage for future drilling operations.

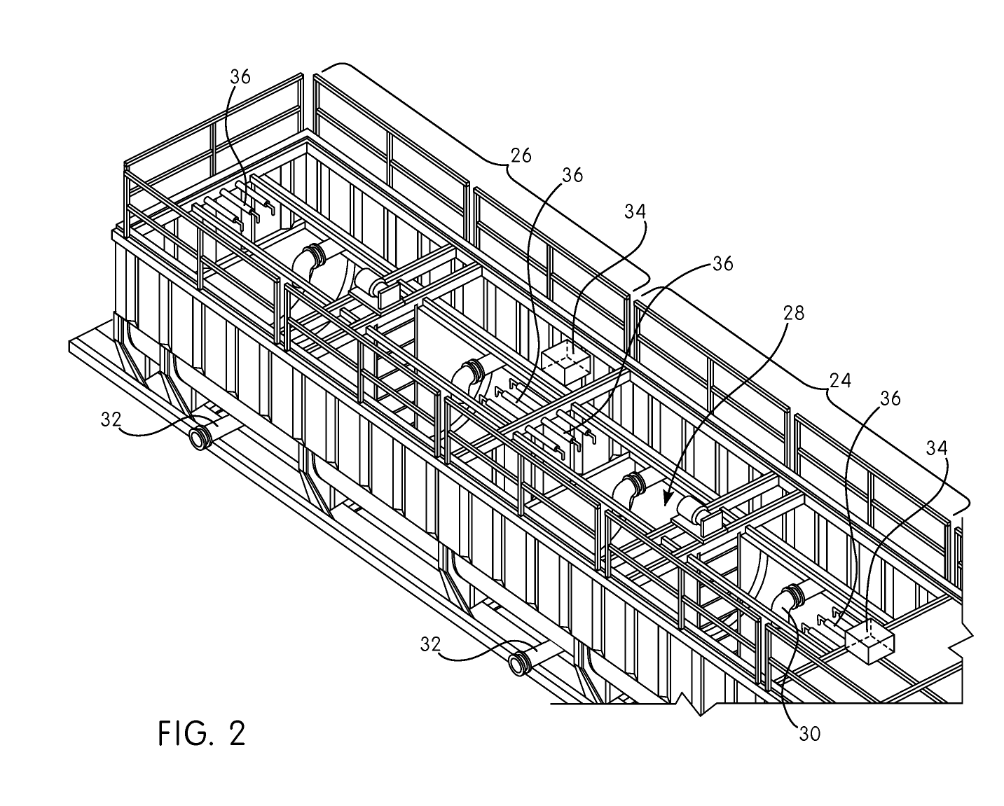

Referring now to FIG. 2, in accordance with an exemplary embodiment, there is illustrated a pair of drilling fluid tanks 24, 26, each having a plurality of sidewalls, and defining an interior space 28, therein, with at least one inlet 30 and one outlet 32 for allowing drilling fluid to flow therethrough during operation. The drilling fluid tanks 24, 26 may be of the type that is utilized at a drilling site or in any other setting, which may have a high flow of fluid therethrough during cleaning of the drilling fluid tanks. Such drilling fluid tanks are cleaned after the drilling fluids have been spent or drained therefrom.

In an aspect of the exemplary embodiment, the drilling site can include a plurality of drilling fluid tanks for storing drilling fluid. As further discussed below, each drilling fluid tank 24, 26 is equipped with a pump 34 to reclaim or spray cleaning fluids such as fuel oil, an admixture of drilling fluid and fuel oil, and the like. For example, a cleaning fluid such as fuel oil can be pumped into the drilling fluid tanks 24, 26 in order to wash the interior surfaces of the drilling fluid tanks. Additionally, it is to be understood that alternative embodiments are envisioned in which the pump 34 is part of a separate structure or system adjacent the drilling fluid tanks.

In accordance with an exemplary embodiment, the drilling fluid tanks 24, 26 include a plurality of nozzles 36 configured to inject one or more fluids, such as fuel oil or virgin drilling fluid into the drilling fluid tanks 24, 26. In accordance with an aspect, each nozzle 36 can be inserted into an opening in the drilling fluid tanks 24, 26 and injects fuel oil from an end of the nozzle. Each nozzle 36 can also be rotated. Rotation of the nozzle allows an injection position of the end of the nozzle 36 to be adjusted. As used herein, “virgin drilling fluid” refers to drilling fluid unmixed with significant fuel oil.

In an aspect of the exemplary embodiment, the nozzle 36 may be attached to a flexible hose to remove any debris or residue remaining from walls, floors and internal surfaces of the drilling fluid tanks. For example, a flexible hose can be utilized to specifically direct fluid into any inaccessible areas within a drilling fluid tank.

The nozzle 36 can be adjustably attached to a plurality of locations on the drilling fluid tanks 24, 26. In accordance with an aspect, the fuel oil can be fed from a separate storage tank (not shown) that houses the fuel oil on site during drilling operations.

In accordance with an exemplary embodiment, the pump 34 supplies fuel oil and admixtures of drilling oil and fuel oil at a high rate and pressure through the nozzle 36 described above. For example, the pump may pump fluid at a rate of about 40 to 100 gpm and a pressure of about 120 to 180 psi. The pump may be any pump capable of generating a pressure differential of sufficient magnitude to spray the fuel oil or admixtures out of the nozzle 36 with sufficient velocity to dislodge any solid components.

After the fuel oil has been sprayed into the drilling fluid tanks 24, 26, the fuel oil and drilling fluid within the drilling fluid tanks 24, 26 form a resulting admixture of drilling fluid and fuel oil. The admixture can be reclaimed via drainage, suction, siphoning or other means. As shown in FIG. 2, the admixture can be reclaimed through outlet 32. As further discussed below, the resulting admixture can be recycled and reused for cleaning and drilling operations.

In an aspect of the exemplary embodiment, pumps e.g., hydraulic pumps or air pumps can be used to reclaim the resulting admixture in the first tank 24 and use it to clean the residual drilling fluid in the second tank 26. This process can be repeated to continuously clean a plurality of drilling fluid tanks located at a drilling site. For example, a second admixture is formed by the first admixture and the drilling fluid from the second tank 26. The reclaimed second admixture can be used to wash drilling fluid in a third tank (not shown). Thereafter, the pumps can then be used to reclaim the resulting admixture in the third tank and use it to spray the drilling fluid in a fourth tank. This process can be repeated until all of the drilling fluid tanks have been cleaned.

Upon completion of cleaning operations, the resulting final admixture can be used as drilling fluid for subsequent drilling operations. The resulting admixture can be reused on the same drilling site or can be transported to another drilling site for further drilling operations.

In sum, fuel oil is received from an external tank to the pump 34 of the drilling fluid tanks 24, 26. The pump 34 is used to pump the fuel oil into the drilling fluid tanks 24, 26 e.g., via the nozzle 36. Specifically, the fuel oil is sprayed or discharged inside the drilling fluid tank in order to wash the internal surfaces of the drilling fluid tank, such as when the drilling fluid tank is emptied. The fuel oil can be sprayed into the drilling fluid tanks using an automated nozzle assembly having a plurality of directional nozzles. The automated nozzle assembly can be mounted or adjustably secured to a surface of the drilling fluid tanks or structure attached to or adjacent the drilling fluid tanks.

The use of fuel oil to wash drilling fluid forms a first admixture of drilling fluid and fuel oil in the first tank. Subsequently, the first admixture can be reclaimed e.g., via a drainage system, and directed into the second tank for washing the drilling fluid in the second tank. The admixtures can be reused and recycled until all of the tanks have been cleaned.

In accordance with an aspect of the exemplary embodiment, the first admixture comprises at least 50 mass % fuel oil, at least 60 mass % fuel oil, at least 70 mass % fuel oil, at least 80 mass % fuel oil, or at least 90 mass % fuel oil.

The fuel oil can be e.g., diesel, gasoline, kerosene, crude oil and the like.

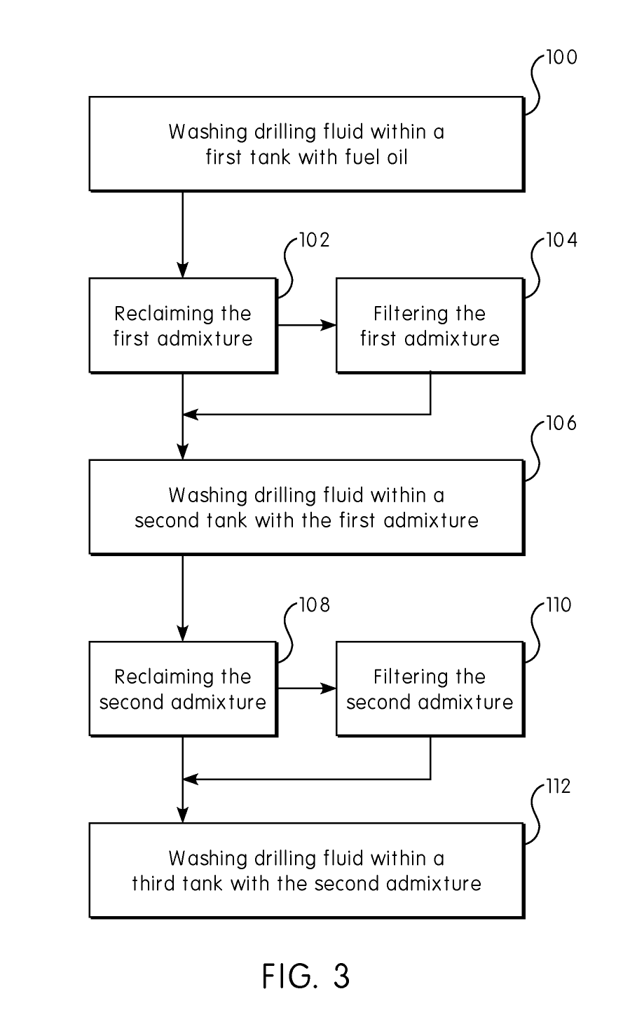

FIG. 3 is an exemplary flow diagram illustrating an aspect of a method of cleaning drilling fluid tanks on a drilling site. The method includes washing drilling fluid within a first tank with fuel oil thereby forming a first admixture of drilling fluid and fuel oil (step 100). As discussed above, the step of washing drilling fluid includes spraying the drilling fluid and inner surfaces of the drilling fluid tanks with the fuel oil. Specifically, the fuel oil is pressurized to generate a sufficiently high fluid velocity to scrub the inner surfaces of the drilling fluid tanks and to dislodge any settled solids in the drilling fluid stored in the drilling fluid tanks.

After washing the drilling fluid in the first tank, the first admixture is reclaimed (step 102). Specifically, the admixture can be reclaimed through a variety of methods (e.g., drainage, suction, siphoning, etc.). In an aspect of the exemplary embodiment, hydraulic pumps or air pumps can be used to reclaim the resulting first admixture in the first tank. The reclaimed first admixture is then filtered through a filtration system to help purify the reclaimed first admixture (step 104). Thereafter, the drilling fluid in a second tank is washed with the reclaimed first admixture from the first tank (step 106).

Similar to the first admixture in the first tank, a second admixture formed by the reclaimed first admixture and the drilling fluid from the second tank is then reclaimed from the second tank (step 108). The reclaimed second admixture is filtered through the filtration system to help purify the reclaimed second admixture (step 110). Thereafter, the drilling fluid in a third tank is washed with the reclaimed second admixture from the second tank (step 112).

In accordance with an exemplary embodiment, the step of filtering can include filtration by centrifugation, sedimentation, dissolved air flotation, coagulation, and the use of ion-selective or semi-permeable membranes. For example, the step of filtering can include filtration by screening, e.g., using a shale shaker at a requested screen size based on customer preferences. Additionally, the step of washing can include spraying the drilling fluid with the fuel oil at pressures of about 120 to 180 psi.

In an alternate embodiment, the method of forming a cleaning fluid for cleaning drilling fluid tanks on a drilling site may be performed as part of a standalone system. In such an embodiment, the pump may be part of a separate structure or system adjacent the drilling fluid tanks.

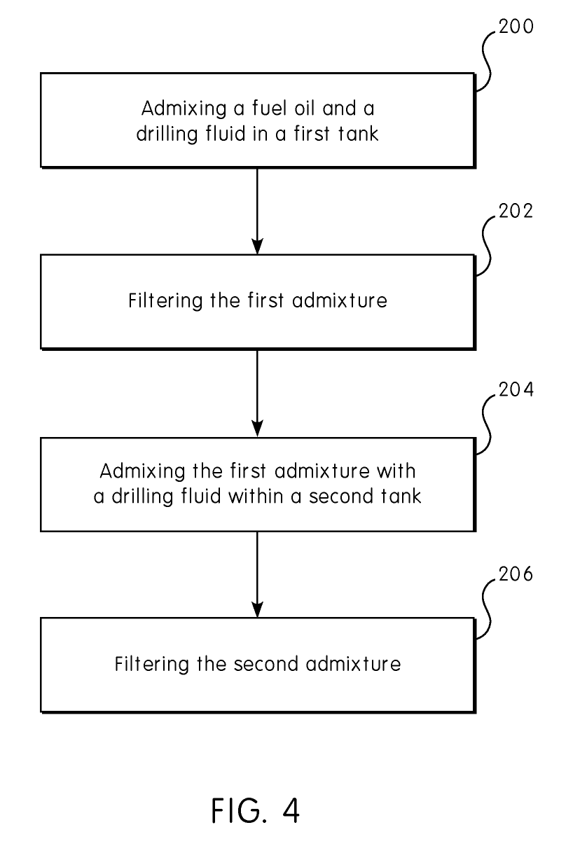

FIG. 4 is an exemplary flow diagram illustrating an aspect of a method of forming a cleaning fluid for cleaning drilling fluid tanks on a drilling site. The method includes admixing a fuel oil and a drilling fluid within a first tank (step 200). As a result, a first admixture of fuel oil and the drilling fluid is formed within the first tank. The first admixture is then filtered e.g., through a filtration system to produce a filtered first admixture from the first tank (step 202). Thereafter, the filtered first admixture is admixed with a drilling fluid within a second tank. A second admixture made up of the first admixture and the drilling fluid is formed within the second tank (step 204). Finally, the second admixture is filtered (step 206). The second admixture formed can then be used, e.g., to clean drilling fluid tanks.

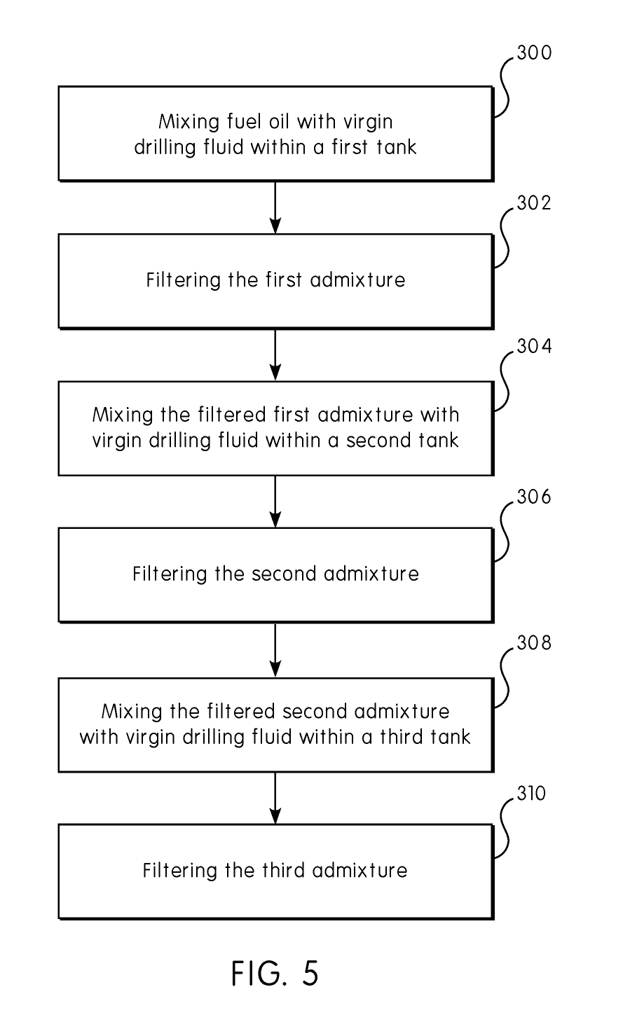

FIG. 5 is an exemplary flow diagram illustrating an aspect of a method of forming a drilling fluid composition for use on a drilling site. The method includes mixing fuel oil with virgin drilling fluid within a first tank (step 300). As a result, a first admixture of fuel oil and virgin drilling fluid is formed within the first tank. The first admixture is then filtered e.g., through a filtration system, to produce a filtered first admixture from the first tank (step 302). Thereafter, the filtered first admixture is mixed with virgin drilling fluid within a second tank. A second admixture made up of the filtered first admixture and the virgin drilling fluid is formed within the second tank (step 304). Then, the second admixture is filtered e.g., through the filtration system, to produce a filtered second admixture from the second tank (step 306).

In accordance with an aspect, the filtered second admixture is mixed with virgin drilling fluid within a third tank. As a result, a third admixture made up of the filtered second admixture and the virgin drilling fluid is formed within the third tank (step 308). Finally, the third admixture is filtered e.g., through the filtration system, to produce a filtered third admixture from the third tank (step 310).

In sum, the subject disclosure provides a method of cleaning drilling fluid tanks. Additionally, the subject disclosure provides a method of forming cleaning fluid for cleaning the drilling fluid tanks, and a method for forming a drilling fluid composition for use with future drilling operations. As discussed above, the drilling fluids, fuel oil, and admixtures thereof, can be recycled for reuse as drilling fluids and purified for reuse to clean drilling fluid tanks. Specifically, the finalized admixtures can be used as drilling fluid in future drilling operations. The foregoing exemplary embodiments of the subject disclosure advantageously provides a means to better clean drilling fluid tanks, recycle environmentally harmful products into usable engineering fluids, and improve drilling site operations by reducing costs associated with cleaning drilling fluid tanks by utilizing on site fuel oil and eliminating disposal costs associated with conventional drilling tank drainage fluids.

While the subject disclosure has been described with reference to exemplary embodiments, it will be appreciated by those skilled in the art that various changes may be made and equivalents may be substituted for elements thereof without departing from the scope of the subject disclosure. In addition, modifications may be made to adapt a particular situation or material to the teachings of the exemplary embodiments without departing from the essential scope thereof. It is to be understood, therefore, that the exemplary embodiments not be limited to the particular aspects disclosed, but it is intended to cover modifications within the spirit and scope of the subject disclosure as defined by the appended claims.

I/We claim:

1. A method of cleaning drilling fluid tanks comprising:
washing drilling fluid within a first tank with fuel oil thereby forming a first admixture of drilling fluid and fuel oil;
reclaiming the first admixture; and
washing drilling fluid within a second tank with the reclaimed first admixture.

2. The method of claim 1, further comprising:
reclaiming a second admixture formed by the first admixture and the drilling fluid from the second tank; and
washing drilling fluid within a third tank with the reclaimed second admixture.

3. The method of claim 1, further comprising the step of filtering the first admixture before washing the second tank.

4. The method of claim 3, wherein the step of filtering includes filtration by shale shaker.

5. The method of claim 1, wherein the step of washing includes spraying the drilling fluid with the fuel oil at pressures of about 120 to 180 psi.

6. The method of claim 1, wherein the fuel oil is at least one of a diesel fuel, gasoline, kerosene and crude oil.

7. The method of claim 1, wherein the first tank is located at a drilling site.

8. A method of forming a cleaning fluid for cleaning drilling fluid tanks comprising:
admixing a fuel oil and a drilling fluid within a first tank forming a first admixture;
filtering the first admixture; and
admixing the first admixture with a drilling fluid within a second tank forming a second admixture.

9. The method of claim 8, further comprising the step of filtering the second admixture.

10. The method of claim 8, wherein the first admixture comprises at least 50 mass % fuel oil.

11. The method of claim 8, wherein the fuel oil is at least one of a diesel fuel, gasoline, kerosene and crude oil.

12. The method of claim 8, wherein the first tank is located at a drilling site.

13. A method of forming a drilling fluid composition comprising:
mixing fuel oil with virgin drilling fluid within a first tank thereby forming a first admixture;
filtering the first admixture;
mixing the filtered first admixture with virgin drilling fluid within a second tank thereby forming a second admixture; and
filtering the second admixture.

14. The method of claim 13, further comprising:
mixing the filtered second admixture with virgin drilling fluid within a third tank thereby forming a third admixture.

15. The method of claim 13, further comprising the step of filtering the third admixture.

16. The method of claim 13, wherein the fuel oil is at least one of a diesel fuel, gasoline, kerosene and crude oil.

17. The method of claim 13, wherein the first tank is located at a drilling site.

18. The method of claim 13, wherein the first tank is a mobile tank.
